(19) United States
(12) Patent Application Publication
(10) Pub. No.: US 2019/0316809 A1
(43) Pub. Date: Oct. 17, 2019

(54) PORTABLE BLOWUP UNDERPINNING FOR TRAILERS

(71) Applicants: Sandra Wilburn, Broken Bow, OK (US); Rex Wilburn, Broken Bow, OK (US)

(72) Inventors: Sandra Wilburn, Broken Bow, OK (US); Rex Wilburn, Broken Bow, OK (US)

(21) Appl. No.: 15/954,631

(22) Filed: Apr. 17, 2018

(51) Int. Cl. F24H 3/04; B62D 63/08

(52) U.S. Cl. CPC F24H 3/0429; B62D 63/08

(57) ABSTRACT

A portable blowup underpinning disposed on a bottom surface of a trailer, the portable blowup underpinning including a center portion to contact the bottom surface of the trailer, a perimeter portion disposed around the center portion, and a hot air blower disposed on the perimeter portion to supply air to the perimeter portion.

### BACKGROUND

### 1. Field

The present general inventive concept relates generally to an underpinning for trailers, and specifically, to a portable blowup underpinning for trailers.

### 2. Description of the Related Art

For trailers, underpinnings can serve both decorative and functional purposes. However, traditional underpinnings have not yet been able to meet a functional enough standard to effectively protect the entirety of the undercarriage of a trailer in extremely cold weather.

Therefore, there is a need for a more efficient and effective underpinning for trailers.

### SUMMARY

The present general inventive concept provides a portable blowup underpinning for trailers.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a portable blowup underpinning disposed on a bottom surface of a trailer, the portable blowup underpinning including a center portion to contact the bottom surface of the trailer, a perimeter portion disposed around the center portion, and a hot air blower disposed on the perimeter portion to supply air to the perimeter portion.

The portable blowup underpinning may further include a plurality of trailer securing devices to secure the perimeter portion to the bottom surface of the trailer.

The portable blowup underpinning may further include a plurality of ground securing devices to secure the portable blowup underpinning to the ground.

The portable blowup underpinning may further include a plurality of weights disposed within the perimeter portion.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a bottom perspective view of a portable blowup underpinning, according to an exemplary embodiment of the present general inventive concept; and

FIG. 2 illustrates a side perspective view of the portable blowup underpinning attached to a trailer, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

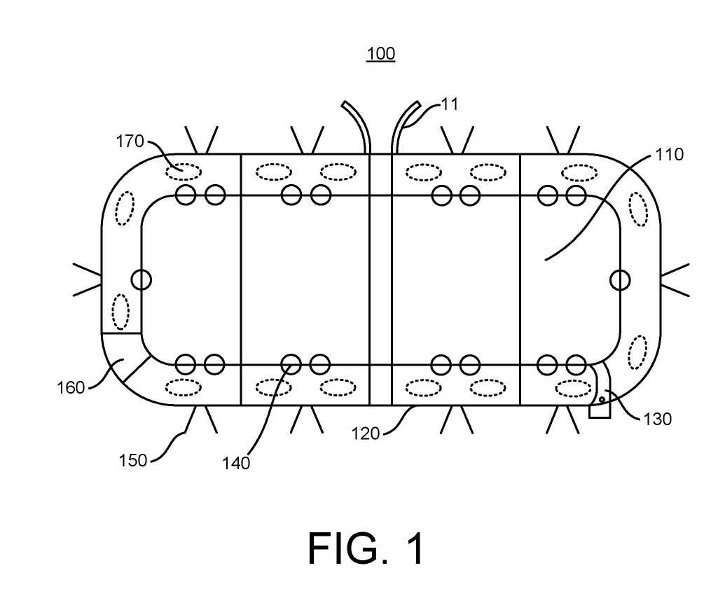

FIG. 1 illustrates a bottom perspective view of a portable blowup underpinning 100, according to an exemplary embodiment of the present general inventive concept.

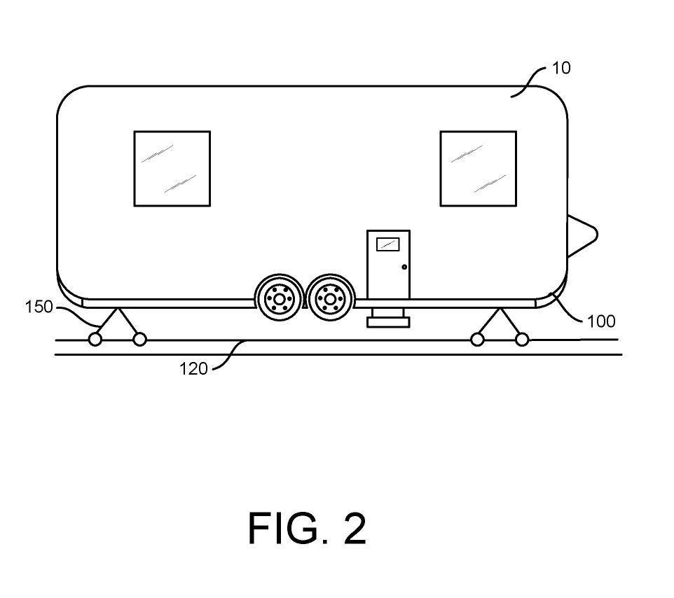

FIG. 2 illustrates a side perspective view of the portable blowup underpinning 100 attached to a trailer 10, according to an exemplary embodiment of the present general inventive concept.

The portable blowup underpinning 100, and components thereof, may be constructed from plastic, rubber, metal, silicone, wood, and any other material known to one of ordinary skill in the art.

Referring to FIGS. 1 and 2, the portable blowup underpinning 100 may include a center portion 110, a perimeter portion 120, a portable hot air blower 130, a plurality of trailer securing devices 140, a plurality of ground securing devices 150, a storage portion 160, and a plurality of weights 170.

The perimeter portion 120 may be disposed around an outside portion of the center portion 110, and may be filled with air from the portable hot air blower 130, which may be attached to a portion of the perimeter portion 120.

The center portion 110 and the perimeter portion 120 may be constructed from puncture-proof material, such as durable rubber, in order to prevent air from escaping therefrom.

The portable blowup underpinning 100 may be attached to a bottom surface of the trailer 10, and secured thereto using the plurality of trailer securing devices 140.

The plurality of trailer securing devices 140 may include ropes, ties, clamps, buttons, etc., but are not limited thereto.

The portable hot air blower 130 may be electronic and/or battery operated, and may blow hot air into the perimeter portion 120 via an aperture in the perimeter portion 120, such that a floor of the trailer 10 is warmed due to the hot air entering the center portion 110 and/or the perimeter portion 120.

When the center portion 110 and/or the perimeter portion 120 is fully inflated and attached to the bottom surface of the trailer 10, cold temperatures and/or frozen ground may not affect water piper 11 disposed at the bottom surface of the trailer 10. In other words, the portable blowup underpinning 100 may protect an area under the trailer 10 from cold weather, such that the portable blowup underpinning 100 may fill a space under the trailer 10 may keep out the cold winter air and protect the water pipes 11 by filling the space with warm air and creating a seal with the puncture resistant perimeter portion 120.

When the center portion 110 and/or the perimeter portion 120 is fully inflated and attached to the bottom surface of the trailer 10, the plurality of ground securing devices 150 may secure the portable blowup underpinning 100 to a ground 10.

The plurality of ground securing devices 150 may include ties, ropes, stakes, etc., but are not limited thereto.

The storage portion 160 may be disposed at a portion of the perimeter portion 120, such that animals and/or objects may be stored therein.

The plurality of weights 170 may be stored within the perimeter portion 120 to add extra stability to the portable blowup underpinning 100.

The present general inventive concept may include a blowup “bladder” with stabilizers that go under and around the trailer up to the floor, in order to prevent wind from going underneath the trailer. The present general inventive concept may prevent a water supply and the floor of the trailer from freezing over. The present general inventive concept is suitable for winter weather as well as warm or rainy weather, providing the ultimate in under-trailer protection.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A portable blowup underpinning disposed on a bottom surface of a trailer, the portable blowup underpinning comprising:
a center portion to contact the bottom surface of the trailer;
a perimeter portion disposed around the center portion;
a storage portion disposed at a portion of the perimeter portion to store at least one of animals and objects therein; and
a hot air blower disposed on the perimeter portion to supply air to the perimeter portion and the center portion.

2. The portable blowup underpinning of claim 1, further comprising:
a plurality of trailer securing devices to secure the perimeter portion to the bottom surface of the trailer.

3. The portable blowup underpinning of claim 1, further comprising:
a plurality of ground securing devices to secure the portable blowup underpinning to the ground.

4. The portable blowup underpinning of claim 1, further comprising:
a plurality of weights disposed within the perimeter portion.
